(19) United States
(12) Patent Application Publication
(10) Pub. No.: US 2011/0203197 A1
(43) Pub. Date: Aug. 25, 2011

(54) MULTI-FUNCTIONAL ADOBE

(76) Inventors: Saeed NAJAFI, Ramsar (IR); Mehdi FARZPOURMACHIANI, Rasht (IR); Ali FARZPOURMACHIANI, Rasht (IR)

(21) Appl. No.: 13/033,215

(22) Filed: Feb. 23, 2011

Related U.S. Application Data
(60) Provisional application No. 61/307,188, filed on Feb. 23, 2010.

(51) Int. Cl. F16F 7/00; E04C 1/00; E04C 2/38

(52) U.S. Cl. 52/173.1; 52/596; 52/588.1; 52/570

(57) ABSTRACT

An adobe that a group of which can be placed on one another without using a mediator and by means of a vibrator is capable of changing the imposed forces into vibration and finally dissipating them.

Using this adobe, it is possible to build walls in any form and design without employing materials, cement and concrete.

Using this adobe, building walls can be done faster in comparison with building walls by means of traditional and ordinary adobes available in the market.

This adobe may be designed, produced and employed in different sizes and/or dimensions, varying from very small sizes to very large sizes.

It has been a tradition to use cement and concrete as mediator when building walls using ordinary adobes. However, using the new adobe, because of its unique design and features, walls can be built without employing cement, concrete or any other materials, and adobes can be laid in an entirely different method.

The imposed forces on this new adobe can be changed into vibration and finally dissipated by means of a vibration isolation system. This unique feature is absent in ordinary adobes.

Since in this method building walls may be done using less material, employing these new adobes may be more economical.

Since in this method building walls may be done using less material, the built walls are lighter in comparison with the ordinary walls.

Due to the variety in form and size and dimension and employing different composite materials in manufacturing the new adobe and various methods of laying these adobes, the walls laid in this new method employing the new adobes in adjacency to magnetic fields and/or electric fields and/or electromagnetic fields and/or radiation fields and/or in adjacency to the sources of emitting waves and/or rays with different wave lengths and frequencies neglecting the distance to the source may absolutely operate as a wave insulation and/or a ray insulation and/or a sound insulation and/or a thermal insulation.

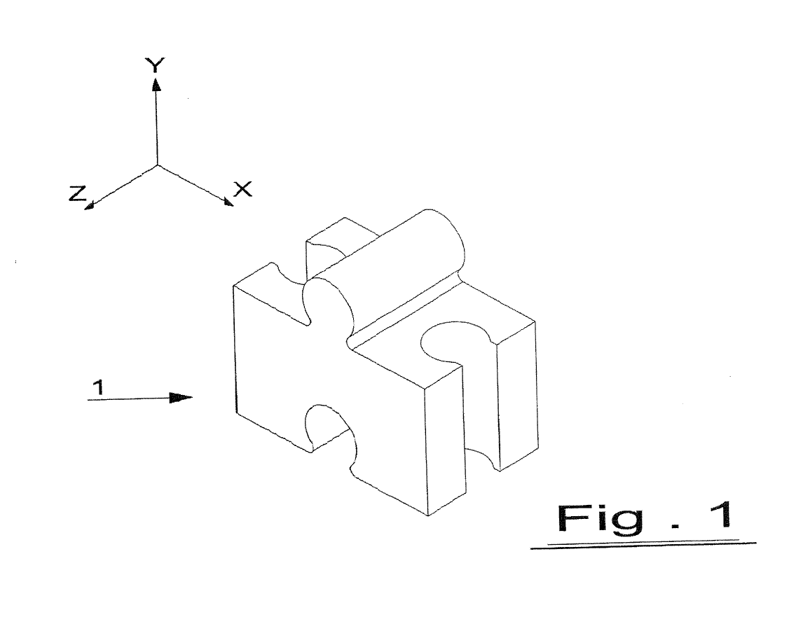

FIG. 1: The general outline of an adobe with one mortise and tenon and two vertical mortises.

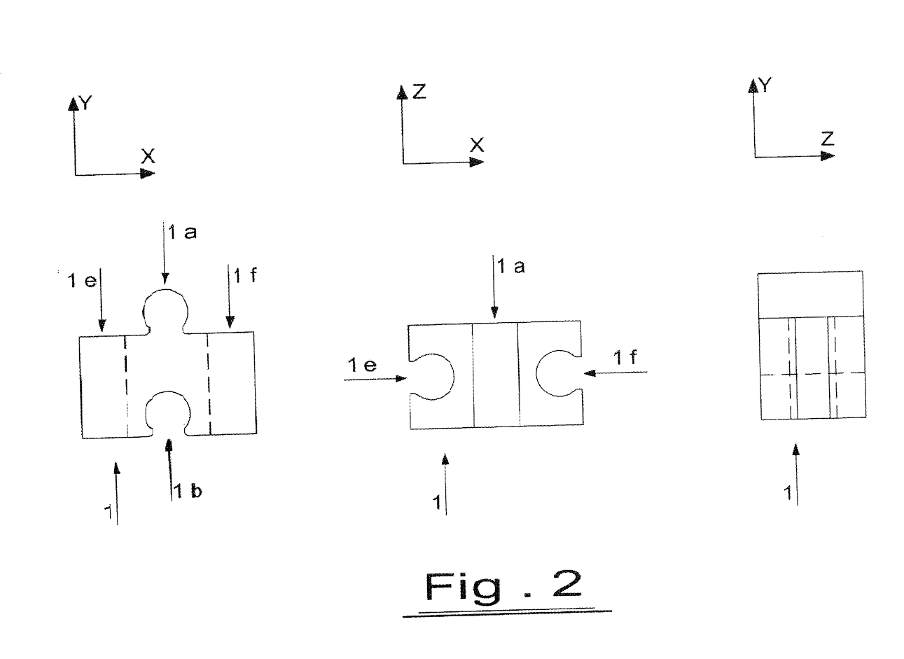

FIG. 2: The general outline of FIG. 1 in (XY), (XZ), and (ZY) views.

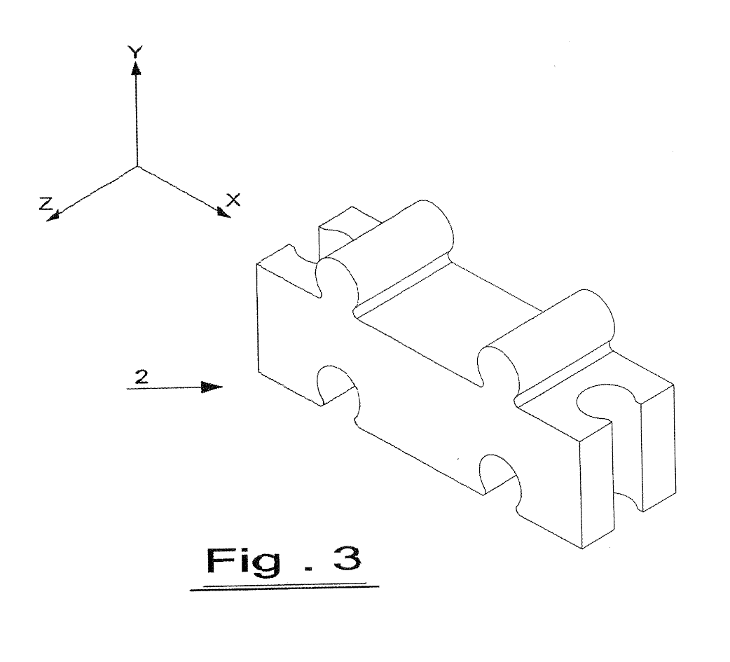

FIG. 3: The general outline of an adobe with two mortises and tenons and two vertical mortises.

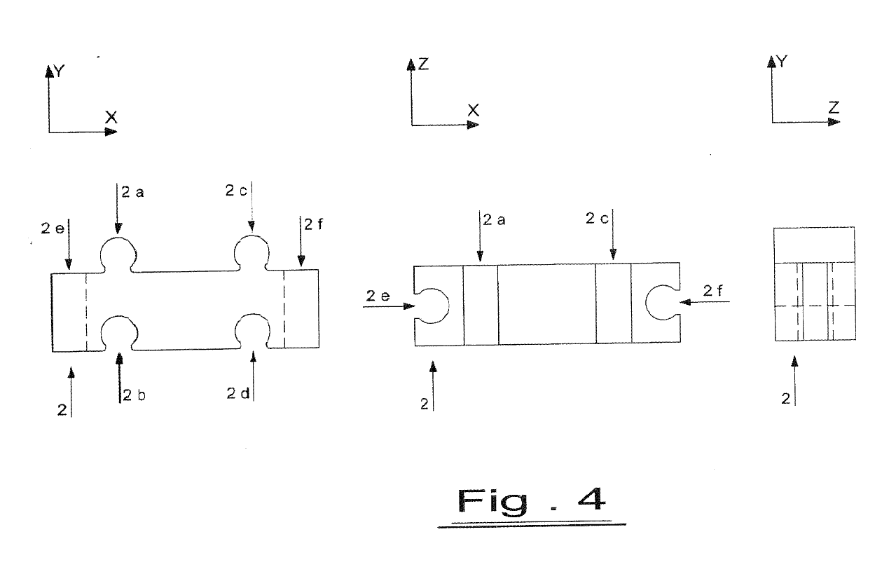

FIG. 4: The general outline of FIG. 3 in (XY), (XZ), and (ZY) views.

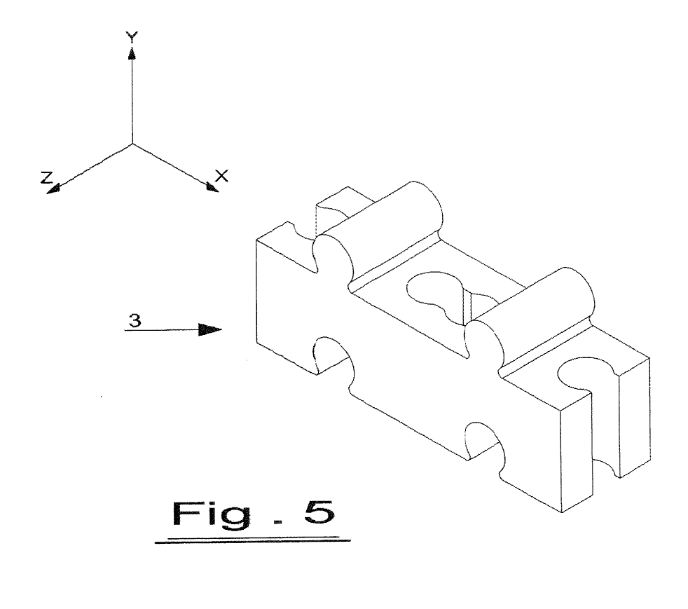

FIG. 5: The general outline of an adobe with two mortises and tenons and two vertical mortises and one vertical inside mortise.

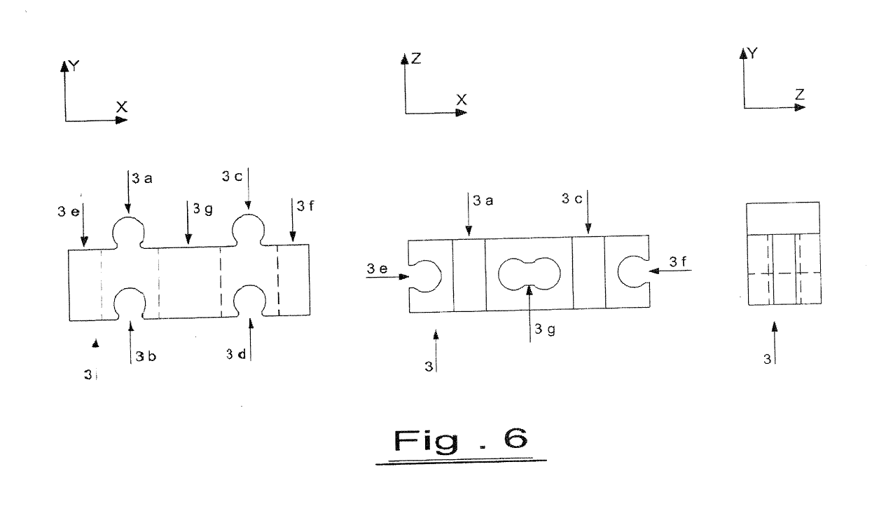

FIG. 6: The general outline of FIG. 5 in (XY), (XZ), and (ZY) views.

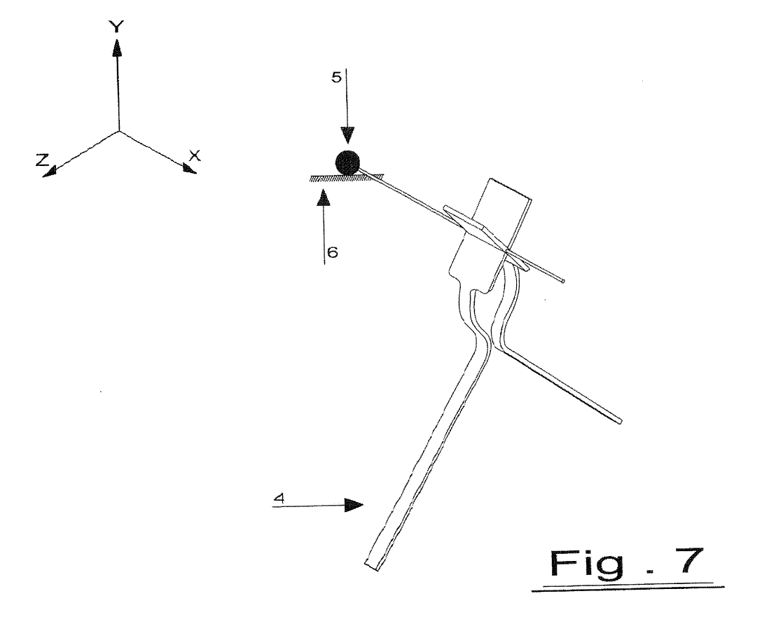

FIG. 7: The general outline of a vibrator.

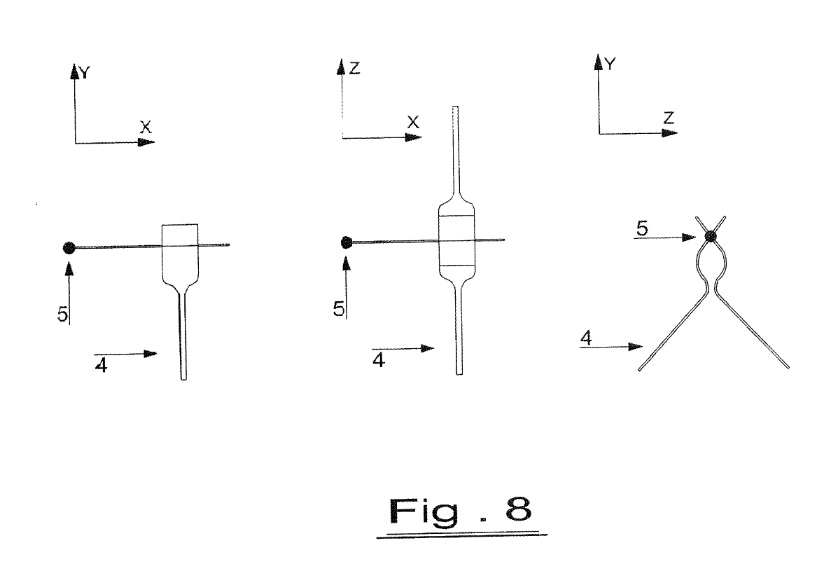

FIG. 8: The general outline of FIG. 7 in (XY), (XZ), and (ZY) views.

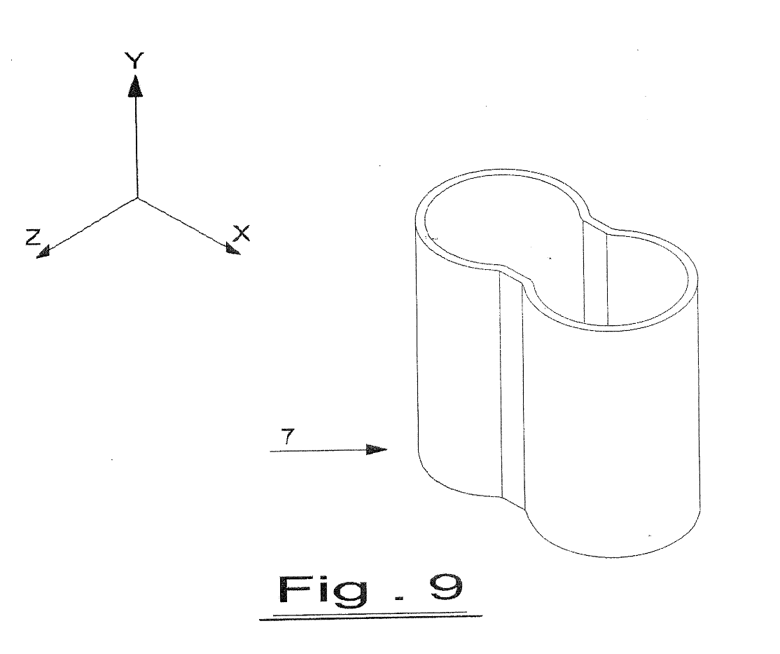

FIG. 9: The general outline of adobes double cylinder coupling.

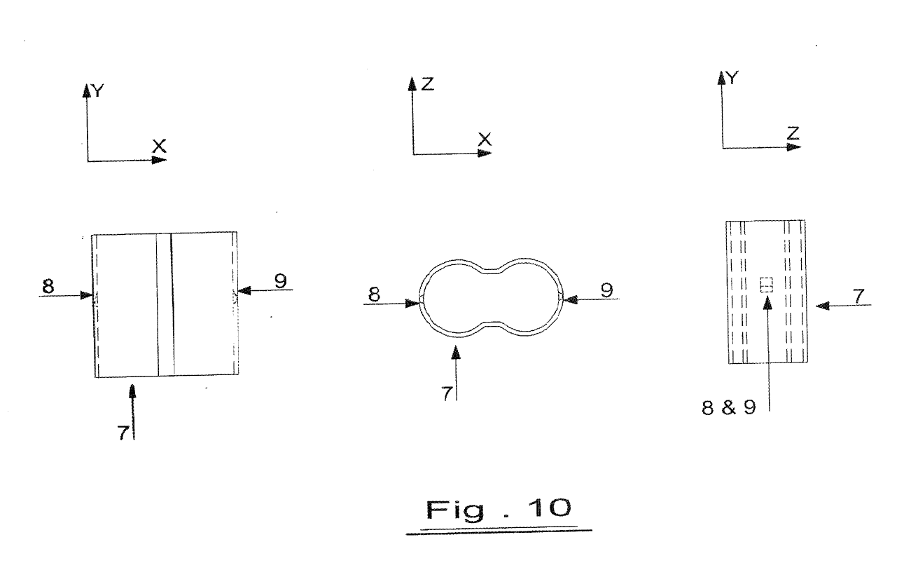

FIG. 10: The general outline of FIG. 9 in (XY), (XZ), and (ZY) views.

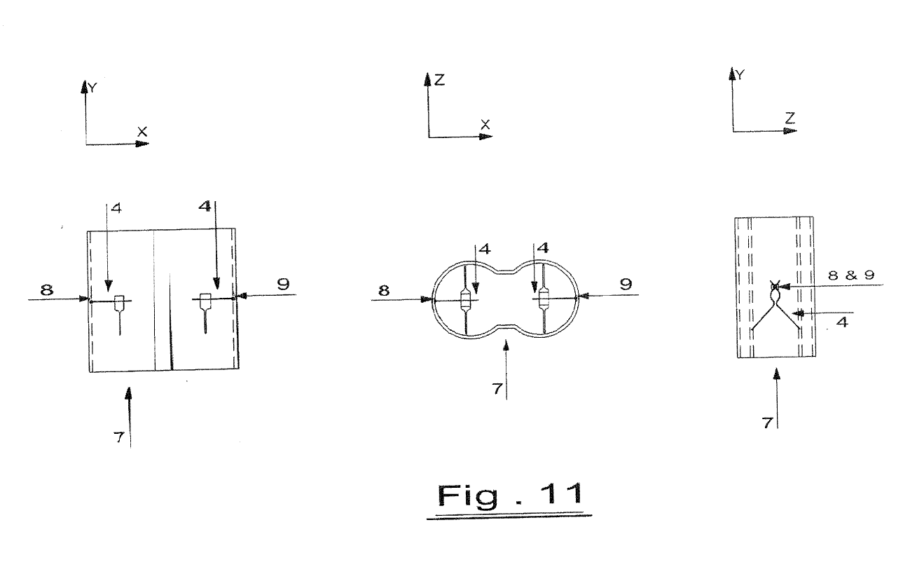

FIG. 11: The general outline of adobes double cylinder coupling with two vibrators in (XY), (XZ), and (ZY) views.

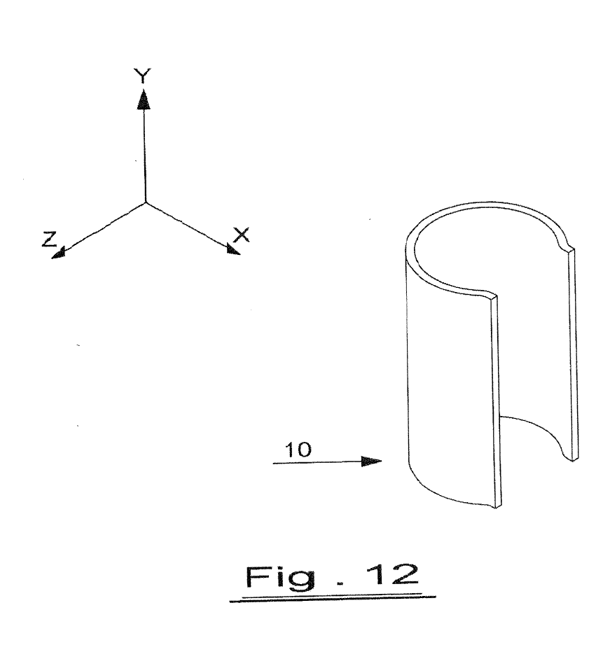

FIG. 12: The general outline of adobes single cylinder coupling.

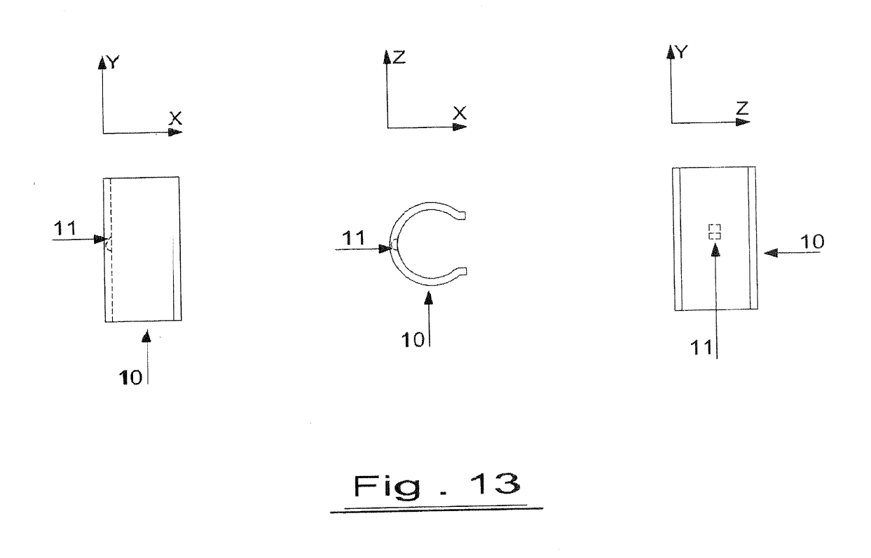

FIG. 13: The general outline of FIG. 12 in (XY), (XZ), and (ZY) views.

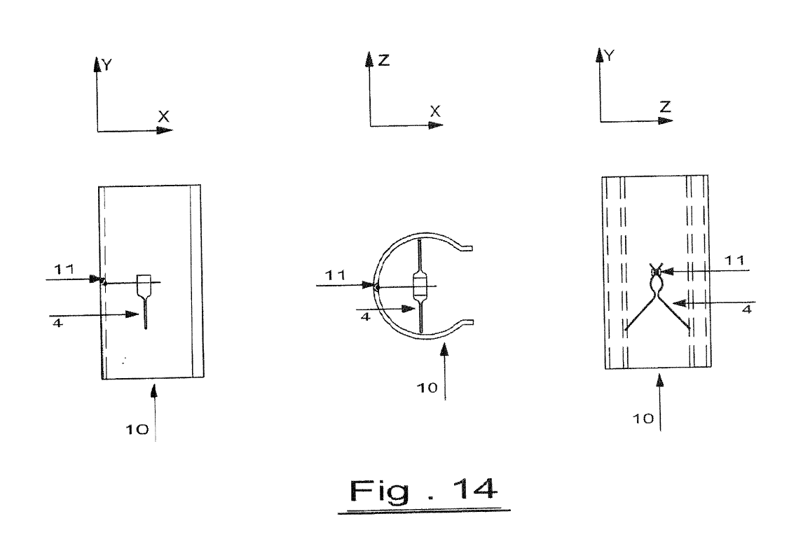

FIG. 14: The general outline of adobes single cylinder coupling with one vibrator in (XY), (XZ), and (ZY) views.

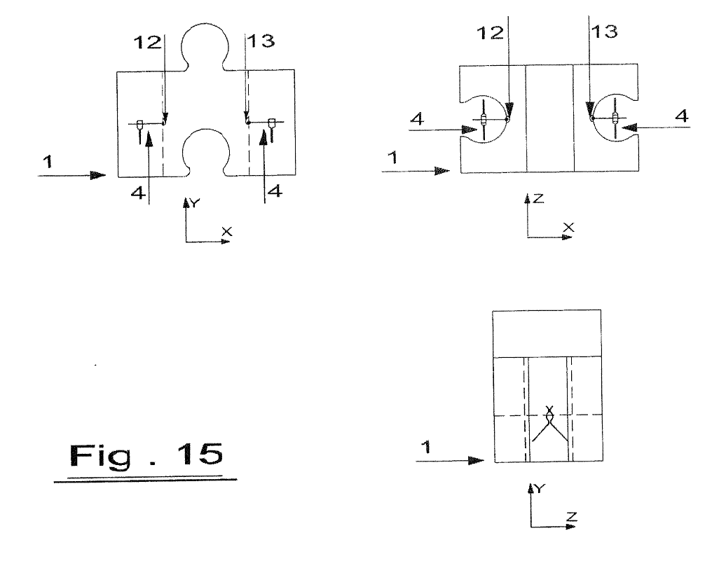

FIG. 15: The general outline of an adobe with one mortise and tenon with one vibrator in each vertical mortise in (XY), (XZ), and (ZY) views.

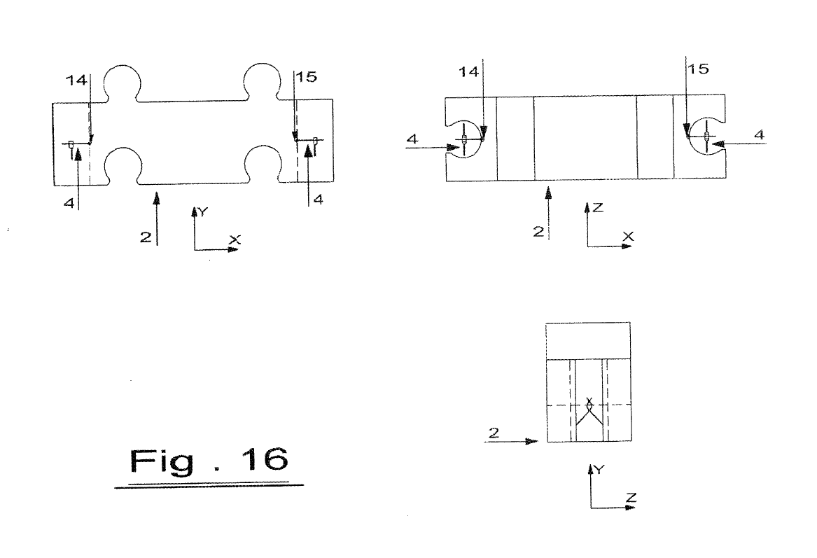

FIG. 16: The general outline of an adobe with two mortises and tenons with one vibrator in each vertical mortise in (XY), (XZ), and (ZY) views.

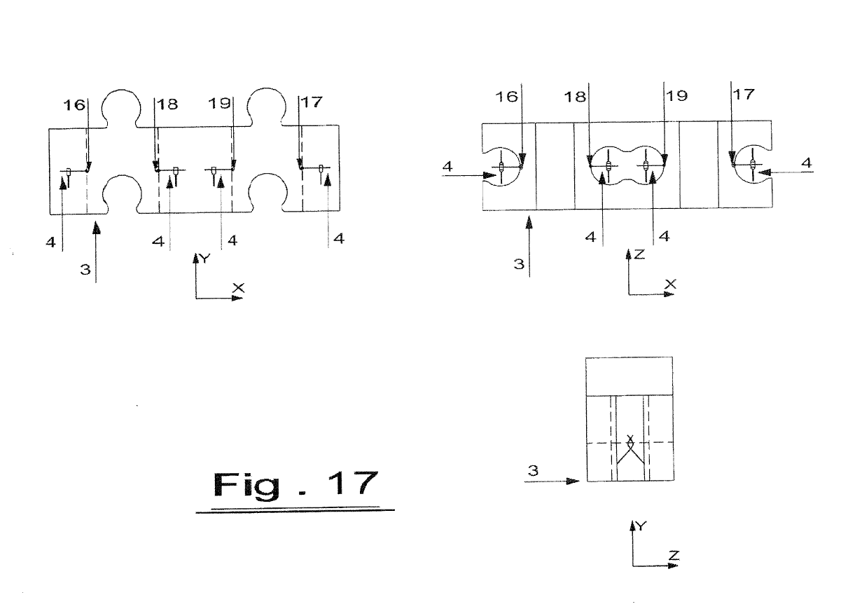

FIG. 17: The general outline of an adobe with two mortises and tenons and one vertical inside mortise with one vibrator in each vertical mortise and two vibrators in vertical inside mortise in (XY), (XZ), and (ZY) views.

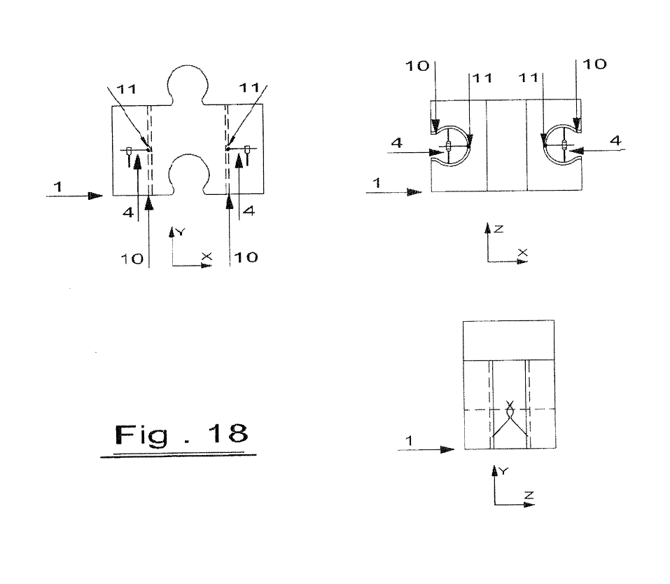

FIG. 18: The general outline of an adobe with one mortise and tenon with adobes single cylinder coupling with one vibrator in each vertical mortise in (XY), (XZ), and (ZY) views.

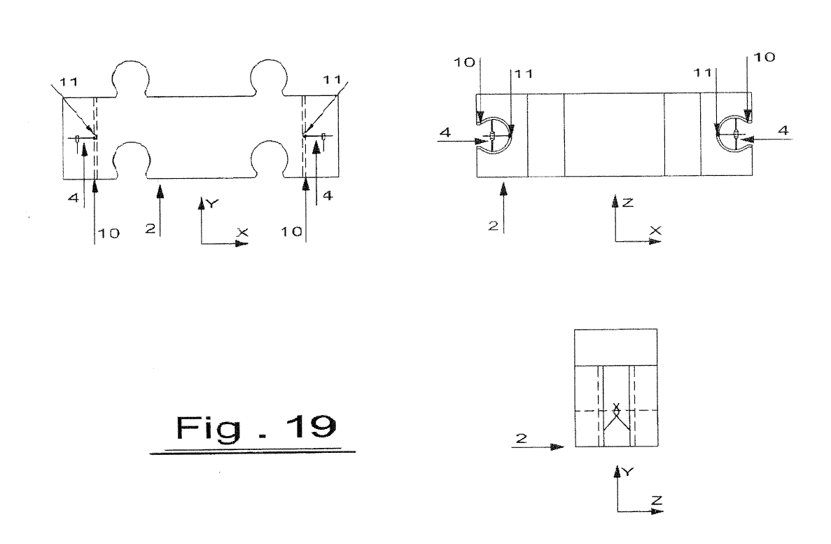

FIG. 19: The general outline of an adobe with two mortises and tenons with adobes single cylinder coupling with one vibrator in each vertical mortise in (XY), (XZ), and (ZY) views.

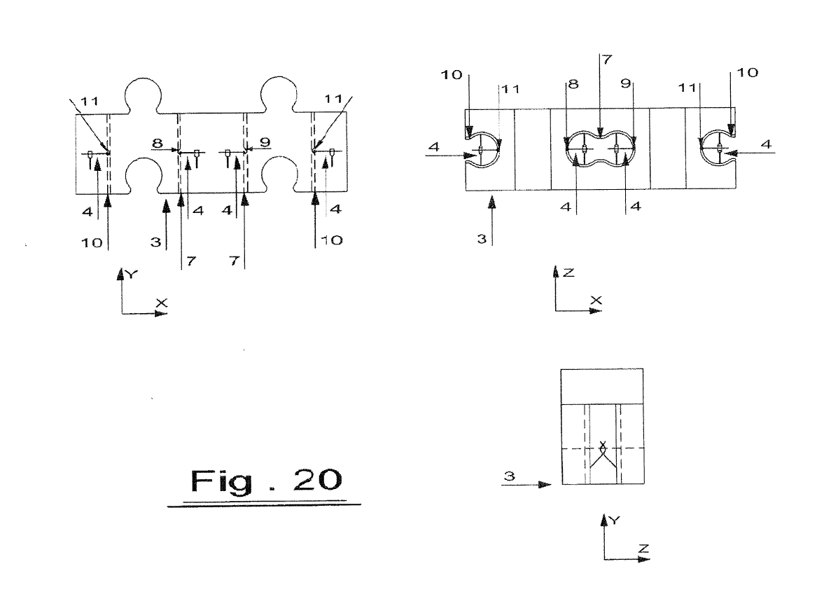

FIG. 20: The general outline of an adobe with two mortises and tenons and one vertical inside mortise with one adobes single cylinder coupling in each vertical mortise with one vibrator and one adobes double cylinder coupling in vertical inside mortise with two vibrators in (XY), (XZ), and (ZY) views.

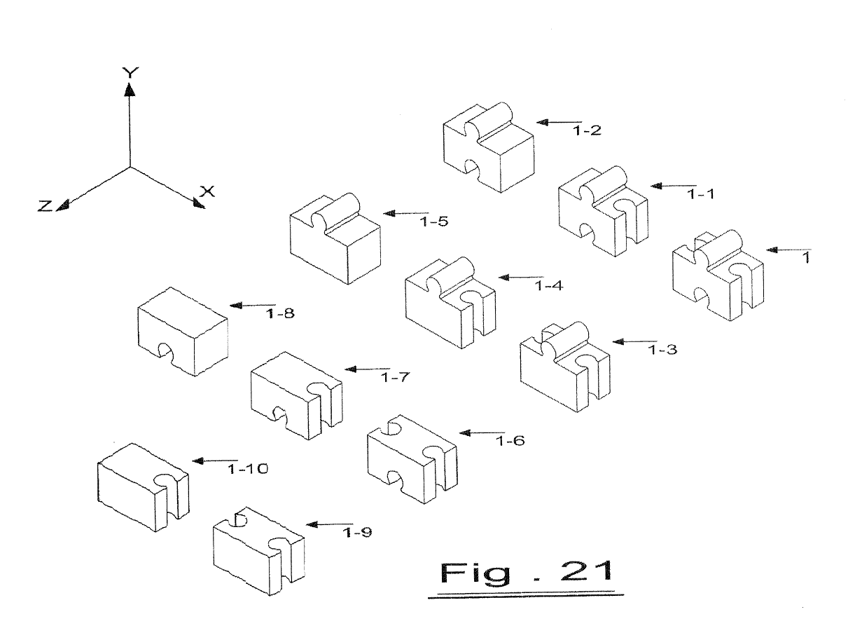

FIG. 21: The general outline of an adobe with one mortise and tenon and two vertical mortises which is shown in different forms.

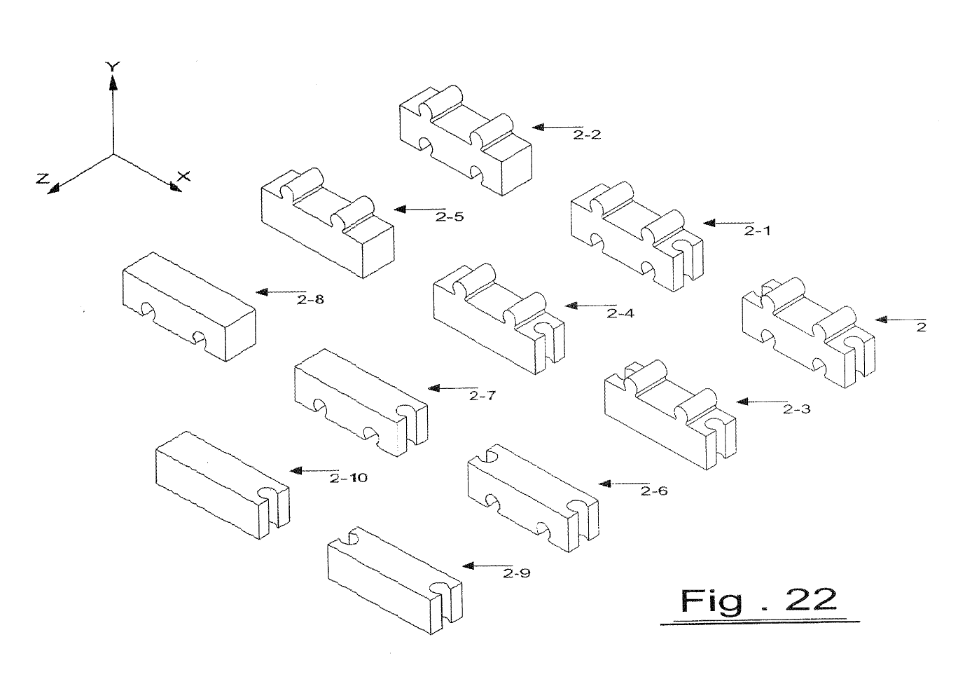

FIG. 22: The general outline of an adobe with two mortises and tenons and two vertical mortises which is shown in different forms.

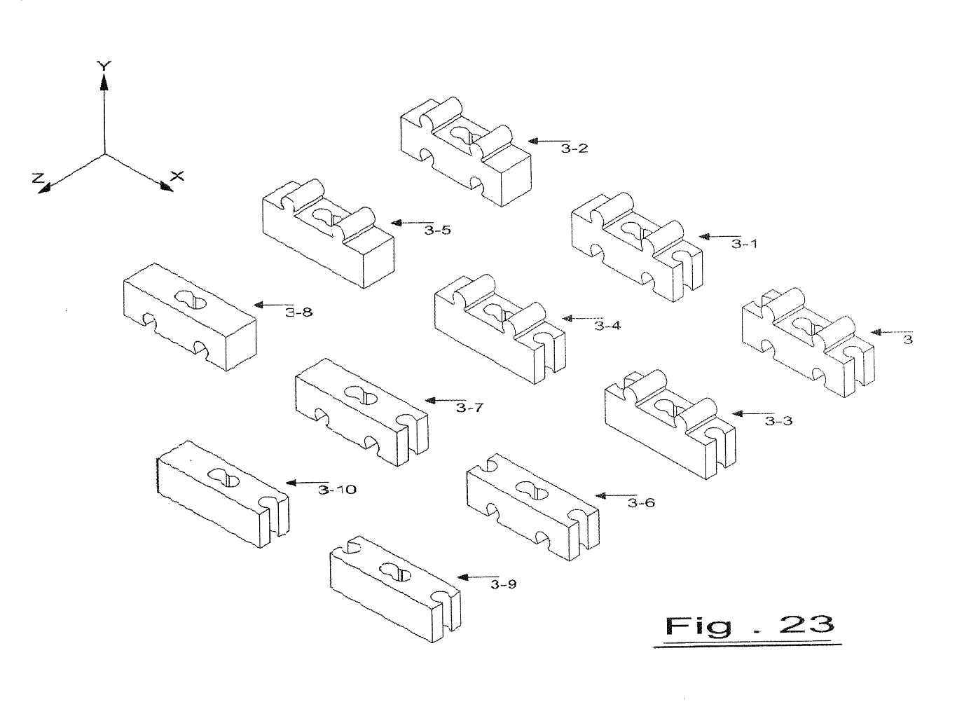

FIG. 23: The general outline of an adobe with two mortises and tenons and two vertical mortises and one vertical inside mortise which is shown in different forms.

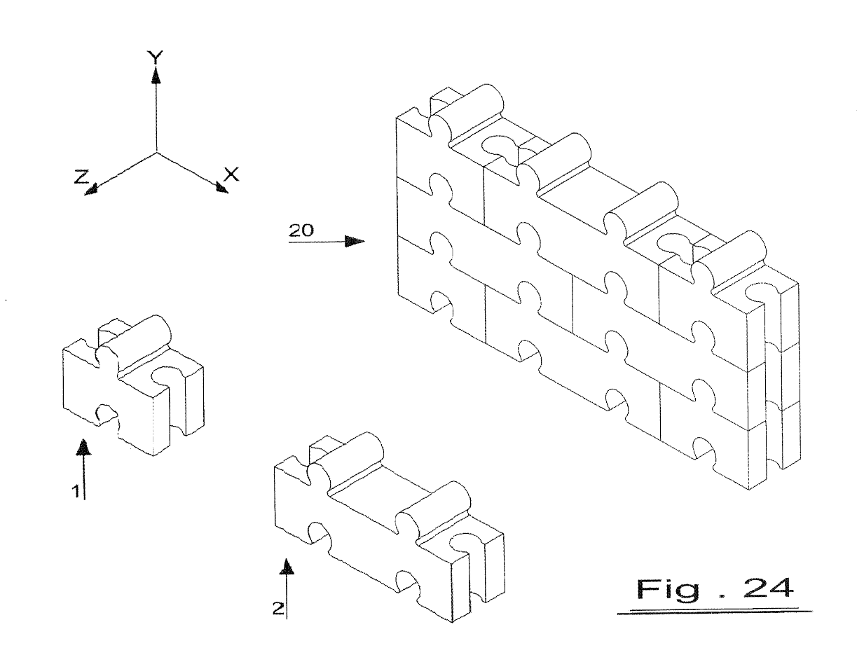

FIG. 24: The general outline of a laid wall which has been built using a combination of a number of adobes 1 and adobes 2.

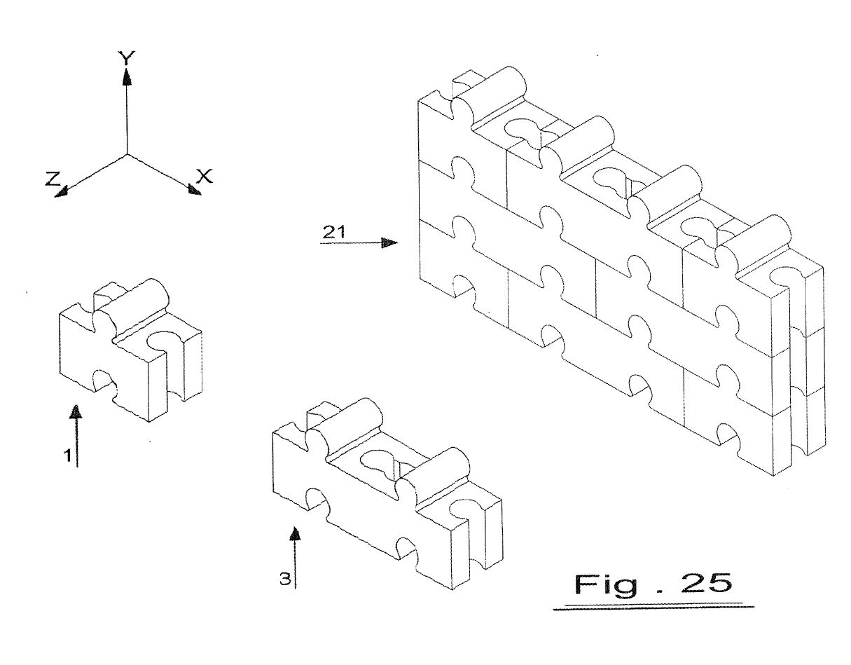

FIG. 25: The general outline of a laid wall which has been built using a combination of a number of adobes 1 and adobes 3.

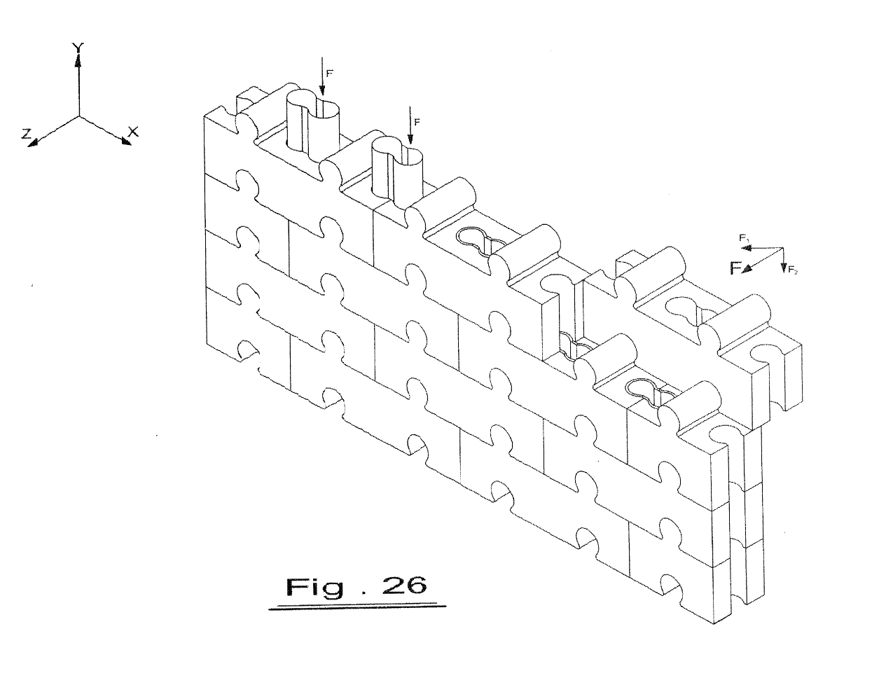

FIG. 26: The general outline of a laid wall which shows the method of laying adobes & adobes double cylinder coupling.

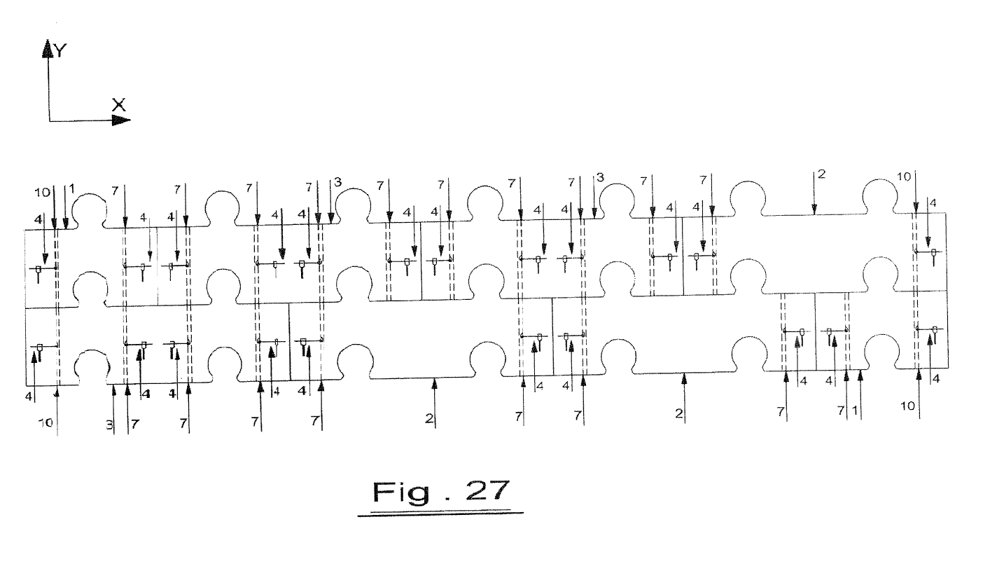

FIG. 27: The general outline of a laid wall with vibrator in (XY) view.

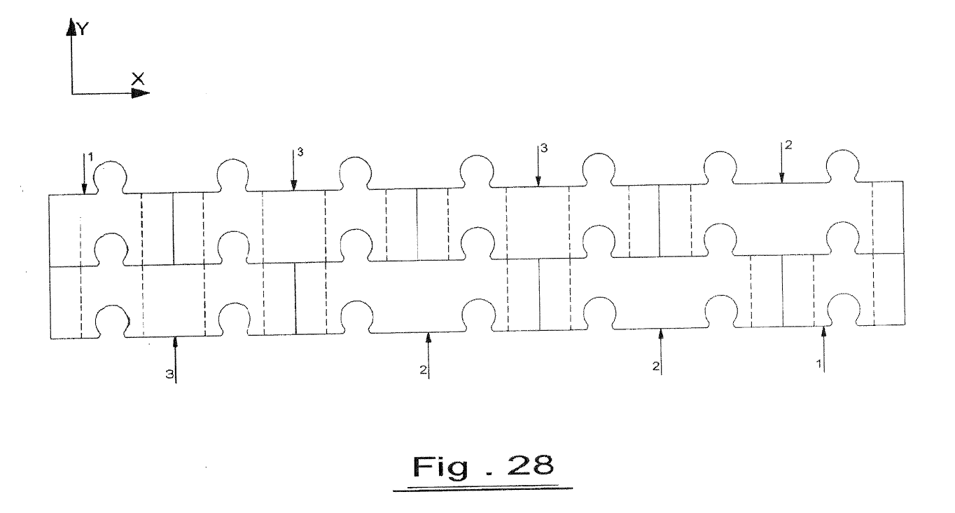

FIG. 28: The general outline of a laid wall without vibrator in (XY) view.

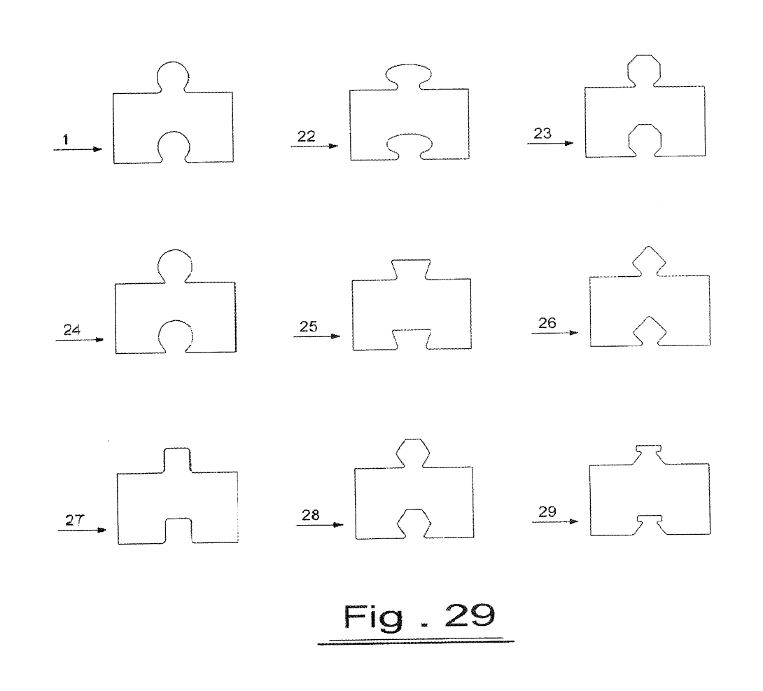

FIG. 29: The general outline of a number of adobes with different designs of mortise and tenon.

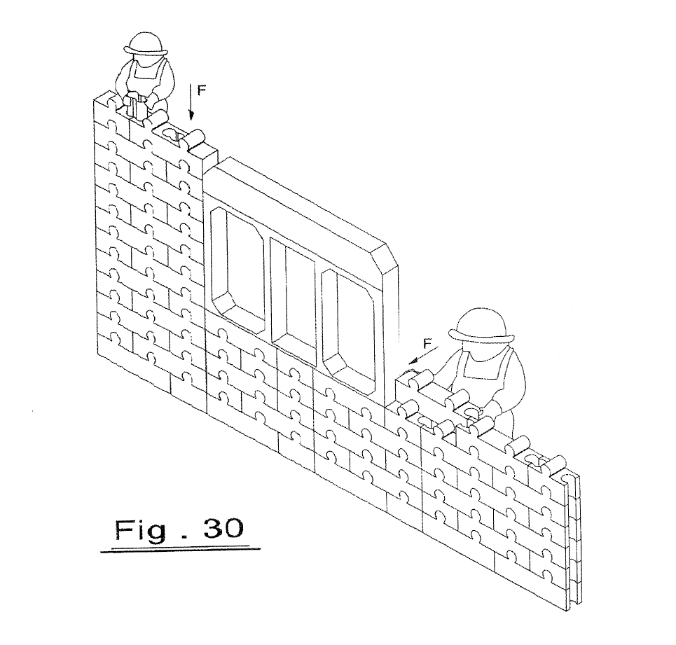

FIG. 30: The general outline of a laid wall and the method with which laying adobes & adobes double cylinder coupling can be done.

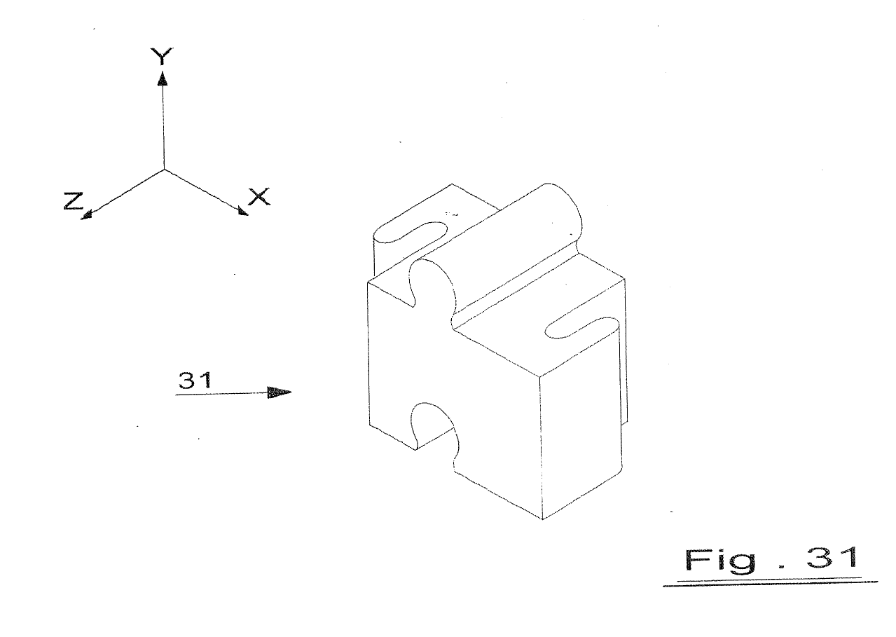

FIG. 31: The general outline of an adobe with one horizontal mortise and tenon, and two vertical mortises, and two vertical tenons.

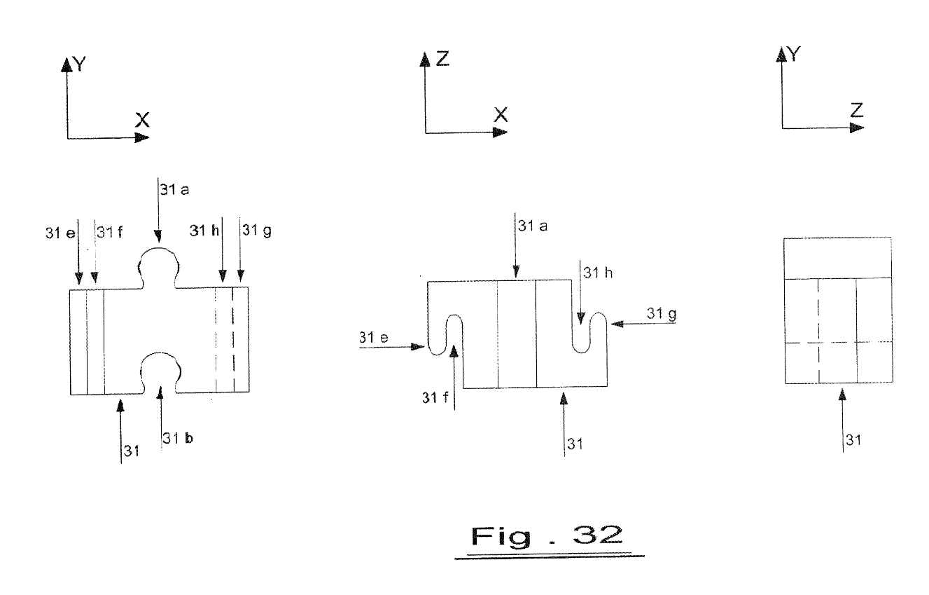

FIG. 32: The general outline of the adobe 31 in (XY), (XZ), and (ZY) views.

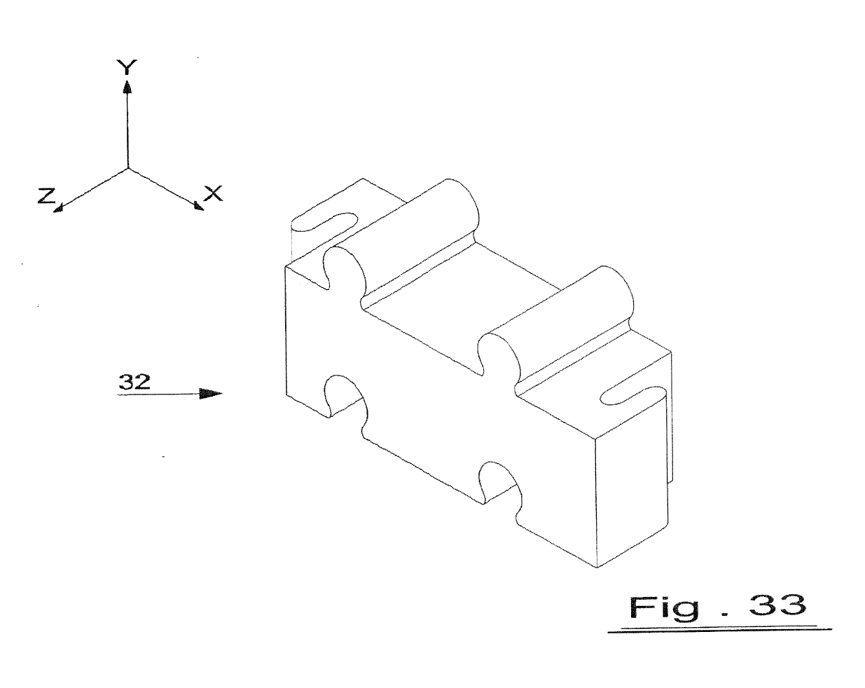

FIG. 33: The general outline of an adobe with two horizontal mortises and tenons, and two vertical mortises, and two vertical tenons.

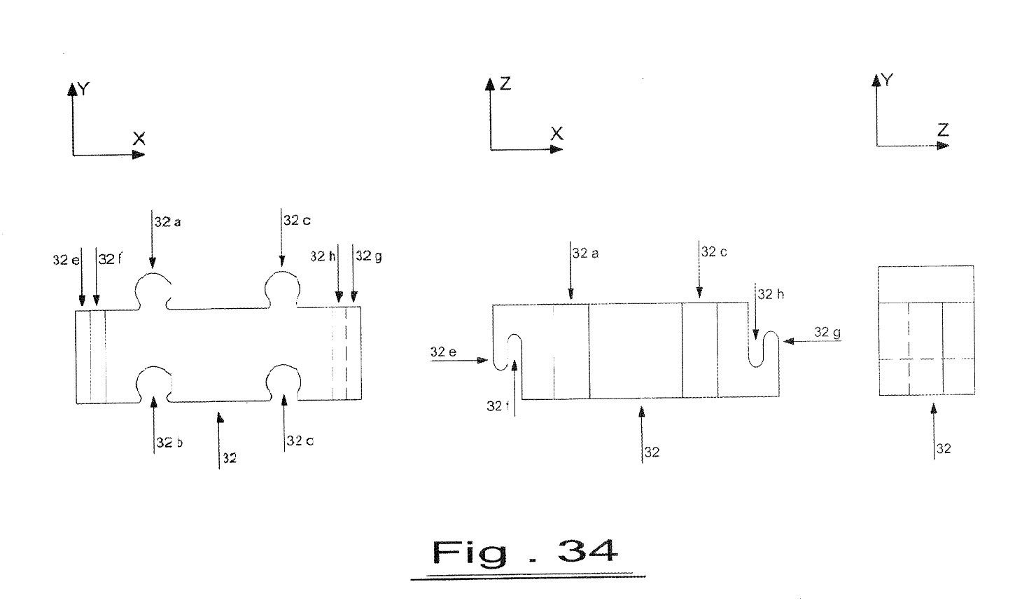

FIG. 34: The general outline of the adobe 32 in (XY), (XZ), and (ZY) views.

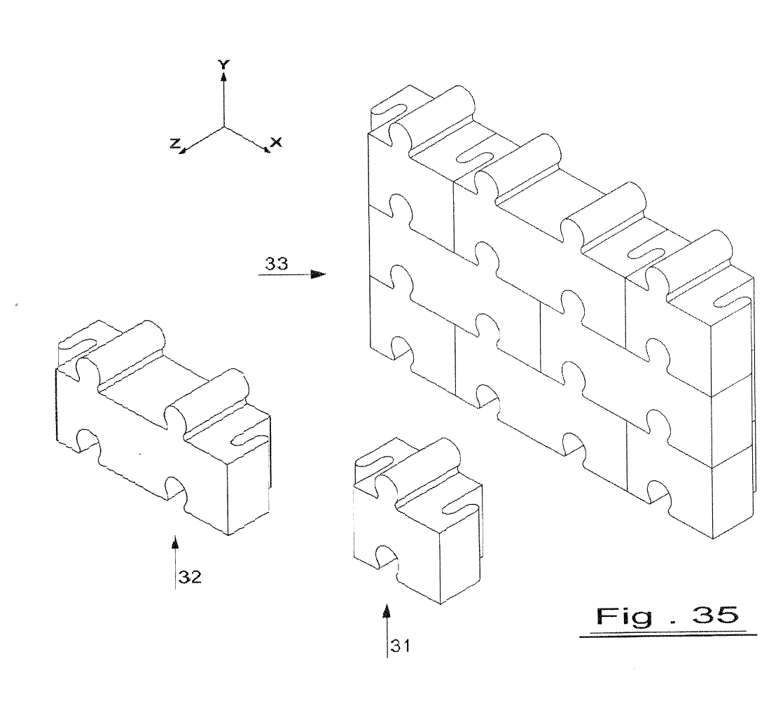

FIG. 35: The general outline of a laid wall using a combination of the adobe 31 and the adobe 32.

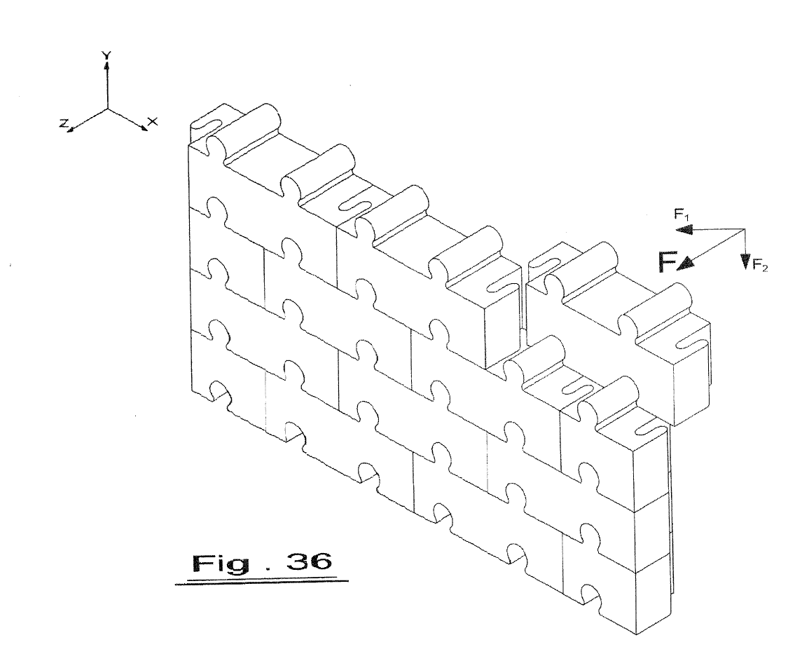

FIG. 36: The general outline of a laid wall which shows the method of laying both adobes.

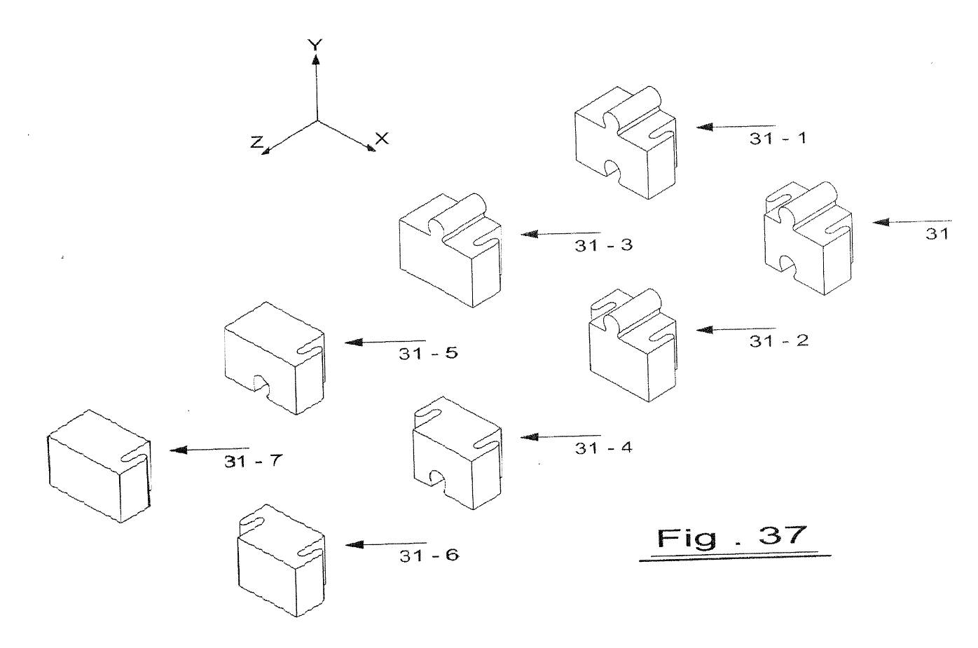

FIG. 37: The general outline of an adobe with one horizontal mortise and tenon, and two vertical mortises, and two vertical tenons which is shown in different forms.

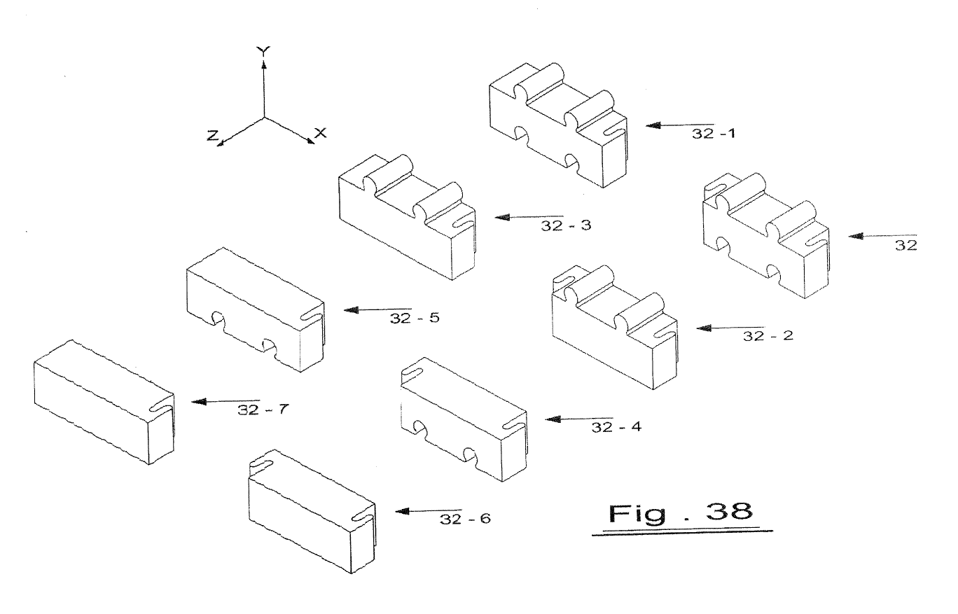

FIG. 38: The general outline of an adobe with two horizontal mortises and tenons, and two vertical mortises, and two vertical tenons which is shown in different forms.

* The following are the parts shown in FIG. 1:

1- Adobe with one mortise and tenon and two vertical mortises.

* The following are the parts shown in FIG. 2:

1- Adobe with one mortise and tenon and two vertical mortises.

1a- Tenon.

1b- Mortise.

1e- Vertical mortise.

1f- Vertical mortise.

* The following are the parts shown in FIG. 3:

2- Adobe with two mortises and tenons and two vertical mortises.

* The following are the parts shown in FIG. 4:

2- Adobe with two mortises and tenons and two vertical mortises.

2a- Tenon.

2b- Mortise.

2c- Tenon.

2d- Mortise.

2e- Vertical mortise.

2f- Vertical mortise.

* The following are the parts shown in FIG. 5:

3- Adobe with two mortises and tenons and two vertical mortises and one vertical inside mortise.

* The following are the parts shown in FIG. 6:

3- Adobe with two mortises and tenons and two vertical mortises and one vertical inside mortise.

3a- Tenon.

3b- Mortise.

3c- Tenon.

3d- Mortise.

3e- Vertical mortise.

3f- Vertical mortise.

3g- Inside mortise.

* The following are the parts shown in FIG. 7:

4- Vibrator.

5- The point at which the vibrator is placed on the support.

6- Support.

* The following are the parts shown in FIG. 8:

4- Vibrator.

5- The point at which the vibrator is placed on the support.

* The following are the parts shown in FIG. 9:

7- Adobes double cylinder coupling.

* The following are the parts shown in FIG. 10:

7- Adobes double cylinder coupling.

8- Support.

9- Support.

* The following are the parts shown in FIG. 11:

4- Vibrator.

7- Adobes double cylinder coupling.

8- Support.

9- Support.

* The following are the parts shown in FIG. 12:

10- Adobes single cylinder coupling.

* The following are the parts shown in FIG. 13:

10- Adobes single cylinder coupling.

11- Support.

* The following are the parts shown in FIG. 14:

4- Vibrator.

10- Adobes single cylinder coupling.

11- Support.

* The following are the parts shown in FIG. 15:

1- Adobe with one mortise and tenon and two vertical mortises.

4- Vibrator.

12- Support (in cases that adobes single cylinder coupling is not used).

13- Support (in cases that adobes single cylinder coupling is not used).

* The following are the parts shown in FIG. 16:

2- Adobe with two mortises and tenons and two vertical mortises.

4- Vibrator.

14- Support (in cases that adobes single cylinder coupling is not used).

15- Support (in cases that adobes single cylinder coupling is not used).

* The following are the parts shown in FIG. 17:

3- Adobe with two mortises and tenons and two vertical mortises and one vertical inside mortise.

4- Vibrator.

16- Support (in cases that adobes single cylinder coupling is not used).

17- Support (in cases that adobes single cylinder coupling is not used).

18- Support (in cases that adobes double cylinder coupling is not used).

19- Support (in cases that adobes double cylinder coupling is not used).

* The following are the parts shown in FIG. 18:

1- Adobe with one mortise and tenon and two vertical mortises.

4- Vibrator.

10- Adobes single cylinder coupling.

11- Support.

* The following are the parts shown in FIG. 19:

2- Adobe with two mortises and tenons and two vertical mortises.

4- Vibrator.

10- Adobes single cylinder coupling.

11- Support.

* The following are the parts shown in FIG. 20:

3- Adobe with two mortises and tenons and two vertical mortises and one vertical inside mortise.

4- Vibrator.

7- Adobes double cylinder coupling.

8- Support.

9- Support.

10- Adobes single cylinder coupling.

11- Support.

* The following are the parts shown in FIG. 21:

1- Adobe with one mortise and tenon and two vertical mortises.

1-1- Adobe with one mortise and tenon and one vertical mortise.

1-2- Adobe with one mortise and tenon.

1-3- Adobe with one tenon and two vertical mortises.

1-4- Adobe with one tenon and one vertical mortise.

1-5- Adobe with one tenon.

1-6- Adobe with one mortise and two vertical mortises.

1-7- Adobe with one mortise and one vertical mortise.

1-8- Adobe with one mortise.

1-9- Adobe with two vertical mortises.

1-10- Adobe with one vertical mortise.

* The following are the parts shown in FIG. 22:

2- Adobe with two mortises and tenons and two vertical mortises.

2-1- Adobe with two mortises and tenons and one vertical mortise.

2-2- Adobe with two mortises and tenons.

2-3- Adobe with two tenons and two vertical mortises.

2-4- Adobe with two tenons and one vertical mortise.

2-5- Adobe with two tenons.

2-6- Adobe with two mortises and two vertical mortises.

2-7- Adobe with two mortises and one vertical mortise.

2-8- Adobe with two mortises.

2-9- Adobe with two vertical mortises.

2-10- Adobe with one vertical mortise.

* The following are the parts shown in FIG. 23:

3- Adobe with two mortises and tenons and two vertical mortises and one vertical inside mortise.

3-1- Adobe with two mortises and tenons and one vertical mortise and one vertical inside mortise.

3-2- Adobe with two mortises and tenons and one vertical inside mortise.

3-3- Adobe with two vertical mortises and two tenons and one vertical inside mortise.

3-4- Adobe with one vertical mortise and two tenons and one vertical inside mortise.

3-5- Adobe with two tenons and one vertical inside mortise.

3-6- Adobe with two mortises and two vertical mortises and one vertical inside mortise.

3-7- Adobe with two mortises and one vertical mortise and one vertical inside mortise.

3-8- Adobe with two mortises and one vertical inside mortise.

3-9- Adobe with two vertical mortises and one vertical inside mortise.

3-10- Adobe with one vertical mortise and one vertical inside mortise.

* The following are the parts shown in FIG. 24:

1- Adobe with one mortise and tenon and two vertical mortises.

2- Adobe with two mortises and tenons and two vertical mortises.

20- A laid wall which has been built using a combination of adobes 1 and adobes 2.

* The following are the parts shown in FIG. 25:

1- Adobe with one mortise and tenon and two vertical mortises.

3- Adobe with two mortises and tenons and two vertical mortises and one vertical inside mortise.

21- A laid wall which has been built using a combination of adobes 1 and adobes 3.

* The following are the parts shown in FIG. 26:

A laid wall which shows the method of laying the adobes along with the resultant force of “F” imposed on the adobe while being laid & shows the method of laying adobes double cylinder coupling.

* The following are the parts shown in FIG. 27:

1- Adobe with one mortise and tenon and two vertical mortises.

2- Adobe with two mortises and tenons and two vertical mortises.

3- Adobe with two mortises and tenons and two vertical mortises and one vertical inside mortise.

4- Vibrator.

7- Adobes double cylinder coupling.

10- Adobes single cylinder coupling.

* The following are the parts shown in FIG. 28:

1- Adobe with one mortise and tenon and two vertical mortises.

2- Adobe with two mortises and tenons and two vertical mortises.

3- Adobe with two mortises and tenons and two vertical mortises and one vertical inside mortise.

* The following are the parts shown in FIG. 29:

1- Adobe with one mortise and tenon and two vertical mortises.

22- An adobe with a different design of one mortise and tenon.

23- An adobe with a different design of one mortise and tenon.

24- An adobe with a different design of one mortise and tenon.

25- An adobe with a different design of one mortise and tenon.

26- An adobe with a different design of one mortise and tenon.

27- An adobe with a different design of one mortise and tenon.

28- An adobe with a different design of one mortise and tenon.

29- An adobe with a different design of one mortise and tenon. p * The following are the parts shown in FIG. 30:

It is a schematic figure which shows a laid wall using the mentioned adobes and adobes double cylinder coupling and the method of laying the adobes by operators.

* The following are the parts shown in FIG. 31:

31- An adobe with one horizontal mortise and tenon, and two vertical mortises, and two vertical tenons.

* The following are the parts shown in FIG. 32:

31- An adobe with one horizontal mortise and tenon, and two vertical mortises, and two vertical tenons.

31a- One horizontal tenon.

31b- One horizontal mortise.

31e- One vertical tenon.

31f- One vertical mortise.

31g- One vertical tenon.

31h- One vertical mortise.

* The following are the parts shown in FIG. 33:

32- An adobe with two horizontal mortises and tenons, and two vertical mortises, and two vertical tenons.

* The following are the parts shown in FIG. 34:

32- An adobe with two horizontal mortises and tenons, and two vertical mortises, and two vertical tenons.

32a- One horizontal tenon.

32b- One horizontal mortise.

32c- One horizontal tenon.

32d- One horizontal mortise.

32e- One vertical tenon.

32f- One vertical mortise.

32g- One vertical tenon.

32h- One vertical mortise.

* The following are the parts shown in FIG. 35:

31- An adobe with one horizontal mortise and tenon, and two vertical mortises, and two vertical tenons.

32- An adobe with two horizontal mortises and tenons, and two vertical mortises, and two vertical tenons.

33- A laid wall using a combination of the adobe 31 and the adobe 32.

* The following are the parts shown in FIG. 36:

A laid wall which shows the method of laying the adobes along with the resultant force of “F” imposed on the adobe while being laid.

* The following are the parts shown in FIG. 37:

31- An adobe with one horizontal mortise and tenon, and two vertical mortises, and two vertical tenons.

31-1- An adobe with one horizontal mortise and tenon, and one vertical mortise, and one vertical tenon.

31-2- An adobe with one horizontal tenon, and two vertical mortises, and two vertical tenons.

31-3- An adobe with one horizontal tenon, and one vertical mortise, and one vertical tenon.

31-4- An adobe with one horizontal mortise, and two vertical mortises, and two vertical tenons.

31-5- An adobe with one horizontal mortise, and one vertical mortise, and one vertical tenon.

31-6- An adobe with two vertical mortises, and two vertical tenons.

31-7- An adobe with one vertical mortise, and one vertical tenon.

* The following are the parts shown in FIG. 38:

32- An adobe with two horizontal mortises and tenons, and two vertical mortises, and two vertical tenons.

32-1- An adobe with two horizontal mortises and tenons, and one vertical mortise, and one vertical tenon.

32-2- An adobe with two horizontal tenons, and two vertical mortises, and two vertical tenons.

32-3- An adobe with two horizontal tenons, and one vertical mortise, and one vertical tenon.

32-4. An adobe with two horizontal mortises, and two vertical mortises, and two vertical tenons.

32-5- An adobe with two horizontal mortises, and one vertical mortise, and one vertical tenon.

32-6- An adobe with two vertical mortises, and two vertical tenons.

32-7- An adobe with one vertical mortise, and one vertical tenon.

FIGS. 1 to 38 attempt to show an adobe a group of which can be laid on one another without using a mediator between the layers. Though no mediator is used while laying the adobes, this adobe benefits form a unique feature with which it can change the imposed shaking forces into vibration and finally dissipate them.

Since these adobes benefit from a unique feature, they can be laid on one another or beside one another.

The unique feature of these adobes gives them the ability of reacting to shaking forces and keeps them attached.

In earthquake-prone areas the safety factor will be increased by using the vibrator 4 which with the help of its unique design is capable of changing the imposed shaking forces into vibration and dissipating them.

So in this new adobe, the safety factor is increased.

1. An adobe and a vibrator which may be made of clay and/or sand and/or gravel and/or gypsum and/or cement and/or lime and/or mud and/or natural fibers and/or artificial fibers and/or wood and/or corkwood and/or paper and/or glass and/or composite and/or raw materials and/or nano-materials and/or nano-technology and/or mica and/or bio and/or tar and/or graphite and/or carbon and/or petrochemical substances and/or metal and/or metals and/or alloy and/or lead (pb) and/or plum bum and/or plumbiferous rocks and/or insulation and/or tufa (tuff) and/or woven plant fibers and/or compacted garbage and/or natural powders and/or artificial powders and/or etc and/or a combination of what hereinbefore mentioned.

2. An adobe and a vibrator which according to claim 1 may be in various sizes and/or dimensions and forms.

3. An adobe which according to claim 1 may have one mortise and tenon and/or several mortises and tenons.

4. An adobe according to claim 1 the mortise and tenon of which may be in any form and/or sizes and/or dimensions and/or etc and/or along with X coordinate axis and/or along with Y coordinate axis and/or along with Z coordinate axis and\or along with XY coordinate axis and/or along with XZ coordinate axis and/or along with ZY coordinate axis and/or a combination of what hereinbefore mentioned.

5. An adobe which according to claim 1 may have one mortise and tenon and/or separate mortises and tenons which may be attached to the adobe by means of bolt and nut and/or pin and/or nail and/or weld and/or rivet and/or adhesive and/or paste and/or glue and/or affix and/or cement and/or the like and/or etc and/or a combination of what hereinbefore mentioned.

6. An adobe a group of which according to claim 1 may be laid on one another without using cement and/or without using any mediator in layers between them and/or may be a combination of what hereinbefore mentioned.

7. An adobe a group of which according to claim 1 may be laid on one another and/or next to one another and/or in any form and/or in any method without using cement and/or without using any mediator in any aspect of adobes and/or may be a combination of what hereinbefore mentioned.

8. An adobe which according to claim 1 may be a brick and/or a block and/or a tile and/or a sun-dried brick and/or a mud brick and/or a cement brick and/or a cement block and/or a concrete block and/or a reinforced concrete block and/or a fire brick and/or a high-alumina brick and/or an acid brick and/or a glazed brick and/or a hard brick and/or a lug brick and/or a pressed brick and/or a hard stock and/or an insulating brick and/or an insulating block and/or an insulating tile and/or a clay brick and/or a red brick and/or a well-burned brick and/or a stretcher and/or a pale brick and/or a facing brick and/or a clinker brick and/or a carborundum brick and/or a calcium-silicate brick and/or a three-quarter brick and/or a silica brick and/or a perforated brick and/or a wire-cut brick and/or a keyed brick and/or a pavement brick and/or a repressed brick and/or a basic brick and/or an ordinary red brick and/or a chrome-magnesit brick and/or a king closer and/or a header and/or a wedge brick and/or a bathroom tile and/or a kitchen tile and/or a glazed-wool tile and/or a cold storage tile and/or a medical tile and/or a radiology tile and/or a radiology brick and/or a radiology block and/or an enamelled brick and/or an air brick and/or a porous brick and/or an engineering brick and/or a first-class brick and/or a refractory brick and/or a lining brick and/or an arc brick and/or a Flemish brick and/or a face brick and/or a paving brick and/or a control block and/or a hallow block and/or a partition block and/or a wood block and/or a wooden nailer block and/or a closer block and/or a building block and/or a building brick and/or a clay block and/or a keyed-surface block and/or a mastic block and/or an anchor block and/or a combination of what hereinbefore mentioned.

9. An adobe which according to claim 1 may be a wave insulation and/or a ray insulation and/or a sound insulation and/or a thermal insulation and/or a combination of what hereinbefore mentioned when in adjacency to magnetic fields and/or electric fields and/or electromagnetic fields and/or radiation fields and/or in adjacency to the sources of emitting waves and rays with different wave lengths and frequencies neglecting the distance to the source.

10. An adobe which by means of a vibration isolator system is capable of changing the imposed shaking forces into vibration and dissipating them.

11. According to claim 10, an adobe which by means of a vibration isolator system or more than one vibration isolator system is capable of changing the imposed shaking forces into vibration and dissipating them.

12. An adobe a group of which can be laid on one another without vibration isolator system.

13. An adobe a group of which can be laid with different methods, horizontally and/or vertically and/or in curve and/or butt and/or in one direction and/or in multiple parallel layouts and/or in multiple skew layouts and/or in multiple vertical layouts and/or along with X coordinate axis and/or along with Y coordinate axis and/or along with Z coordinate axis and\or along with XY coordinate axis and/or along with XZ coordinate axis and/or along with ZY coordinate axis and/or a combination of what hereinbefore mentioned.

14. A system substantially as hereinbefore described with reference to the accompanying drawings.
